(19) United States
(12) Patent Application Publication
(10) Pub. No.: US 2011/0063234 A1
(43) Pub. Date: Mar. 17, 2011

(54) SYSTEM AND METHOD FOR THE MANAGEMENT OF IMAGE BROWSING IN AN ELECTRONIC DEVICE WITH A TOUCH SCREEN

(75) Inventor: Cheng-Han LIU, Tu-Cheng (TW)

(73) Assignee: HON HAI PRECISION INDUSTRY CO., LTD., Tu-Cheng (TW)

(21) Appl. No.: 12/609,132

(22) Filed: Oct. 30, 2009

(30) Foreign Application Priority Data
Sep. 14, 2009 (CN) 200910306937.0

(51) Int. Cl. G06F 3/041; G06F 3/033

(52) U.S. Cl. 345/173; 715/863

(57) ABSTRACT

An image browsing management method detects a touch operation of a user's finger on a touch screen, and analyzes the touch operation to determine a touch type. Then, the method further calls a corresponding pointer program to process the touch operation according to the touch type, so as to adjust or update the image, for example, delete the image, display a next image, a previous image, a next calendar month image, or a previous calendar month image.

### BACKGROUND

1. Technical Field

Embodiments of the present disclosure relate to electronic device management, and particularly to a system and method for the management of image browsing in an electronic device with a touch screen.

2. Description of Related Art

Many touch screens may be used on a mobile phone to receive touch input of a user's finger. The touch input may be used to execute a corresponding function of the mobile phone. For example, the user use the touch screen to open an album in the mobile phone by touching an icon of the album on the touch screen, select an image from the album to browse, and slide the user's finger on the touch screen to move the image. However, if the user want to browse a next image or a previous image, the user needs to press a direction button of the touch screen or a keypad of the mobile phone, corresponding to the next image or the previous image, which may bring a bad user experience to the user.

### BRIEF DESCRIPTION OF THE DRAWINGS

FIG. 1 is a schematic diagram of one embodiment of an electronic device comprising an image browsing system.

FIG. 2 is a block diagram of one embodiment of the image browsing system shown in FIG. 1.

FIG. 3 is a flowchart of one embodiment of a method for the management of image browsing in an electronic device with a touch screen.

FIG. 4A to FIG. 4D are schematic diagrams of one embodiment of displaying a previous image.

FIG. 5A to FIG. 5D are schematic diagrams of one embodiment of displaying images of a next month.

FIG. 6A to FIG. 6D are schematic diagrams of one embodiment of deleting an image.

### DETAILED DESCRIPTION

All of the processes described below may be embodied in, and fully automated via, functional code modules executed by one or more general purpose electronic devices or processors. The code modules may be stored in any type of readable medium or other storage system device. Some or all of the methods may alternatively be embodied in specialized hardware. Depending on the embodiment, the readable medium may be a hard disk drive, a compact disc, a digital video disc, or a tape drive.

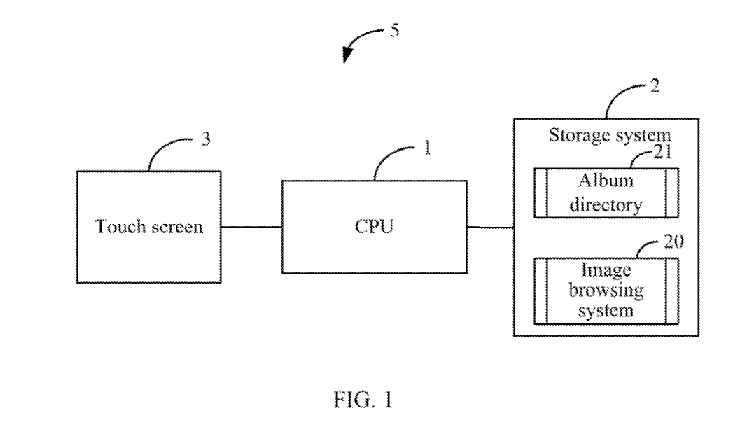

FIG. 1 is a schematic diagram of one embodiment of an electronic device 5 comprising an image browsing system 20. The image browsing system 20 may be used to manage image browsing in the electronic device 5 comprising a touch screen 3 by detecting a touch operation of a user's finger on an image, and analyzing the touch operation to determine a touch type of the touch operation. A corresponding pointer program may be used to process the touch operation according to the touch type, and the image is adjusted or updated using the corresponding pointer program. The new method will make user feel like to use nature behavior to control the real album 21 and enhance user experience. A detailed description will be given in the following paragraphs.

In one embodiment, the electronic device 5 includes a central processing unit (CPU) 1, a storage system 2, and the touch screen 3. The CPU 1 is electronically connected to the storage system 2 and the touch screen 3. In one embodiment, the electronic device 5 may be a cell phone, a digital camera, or a personal digital assistant (PDA), for example.

In one embodiment, the storage system 2 includes an album directory 21 and the image browsing system 20. The album directory 21 is used to store image files. The CPU 1 controls execution of the computerized codes of the image browsing system 20. In one embodiment, the storage system 2 may be a flash memory, and touch screen 3 may be a capacitive touch screen or a resistive touch screen, but the disclosure is not limited thereto.

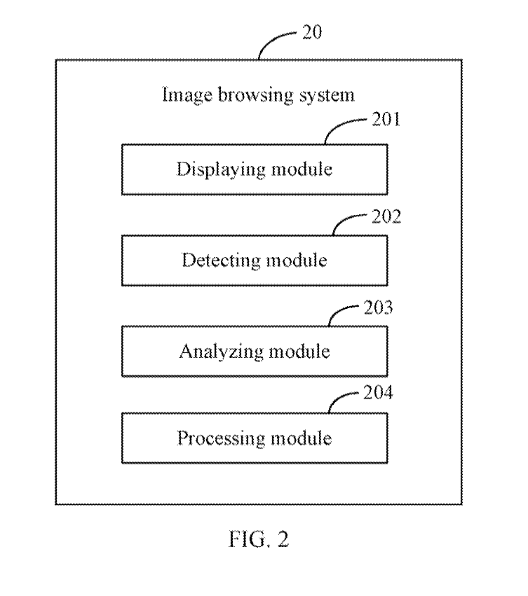

FIG. 2 is a block diagram of one embodiment of the image browsing system 20 in FIG. 1. In one embodiment, the image browsing system 20 includes a displaying module 201, a detecting module 202, an analyzing module 203, and a processing module 204. The modules 201-204 may comprise one or more computerized codes stored in the storage system 2, to be executed by the CPU 1. The storage system 2, depending on the embodiment, may comprise a hard disk drive, volatile, or non-volatile memory, for example.

The displaying module 201 reads image files from the album directory 21 stored in the storage system 2 of the electronic device 5, and displays images of the image files on the touch screen 3 correspondingly.

The detecting module 202 detects a touch operation on the touch screen 3. The touch operation may include a user depressing one or more fingers on a surface of the touch screen. In another example, a stylus may be used to touch the touch screen 3. As mentioned above, the touch screen may be capacitive or resistive.

The analyzing module 203 analyzes the touch operation to determine a touch type of the touch operation. In one embodiment, the touch type may be a tap operation, a slide operation, or a drag operation. If the touch type is the tap operation, touch information of the tap operation may include a touch position of the tap. If the touch type is the slide operation, touch information of the slide operation may include a slide path and a slide direction of the slide. If the touch type is the drag operation, touch information of the drag operation may include a drag path, a drag direction, and a drag distance of the drag. In one embodiment, the slide operation and the drag operation may be differentiated according to a touch time. For example, if the touch time is less than 0.5 seconds, the touch operation is regarded as the slide operation. Otherwise, if the touch time is greater than or equal to 0.5 seconds, the touch operation is regarded as the drag operation.

The processing module 204 calls a corresponding pointer program to process the touch operation according to the touch type. In one embodiment, the pointer program may be a first program for processing the touch operation of the tap operation, a second program for processing the touch operation of the slide operation, or a third program for processing the touch operation of the drag operation. A detailed description is as follows.

If the touch type is the tap operation, the first program is called to adjust a display scale of the image, for example, enlarging the image. If the touch type is the slide operation, the second program is called to display a next image or a previous image according to the slide path and the slide direction. If the touch type is the drag operation, the third program is called to update X-Y-Z coordinates of the image after a preset time interval (e.g., 0.5 seconds) according to the drag path, the drag direction, and the drag distance, and display a next image or a previous image according to the drag path and the drag direction.

For the purpose of illustration, if the touch type is the slide operation and the slide direction is from the top to the bottom of the touch screen 3, the second program is called to display the next image. Otherwise, if the touch type is the slide operation and the slide direction is from the bottom to the top of the touch screen 3, the second program is called to display the previous image.

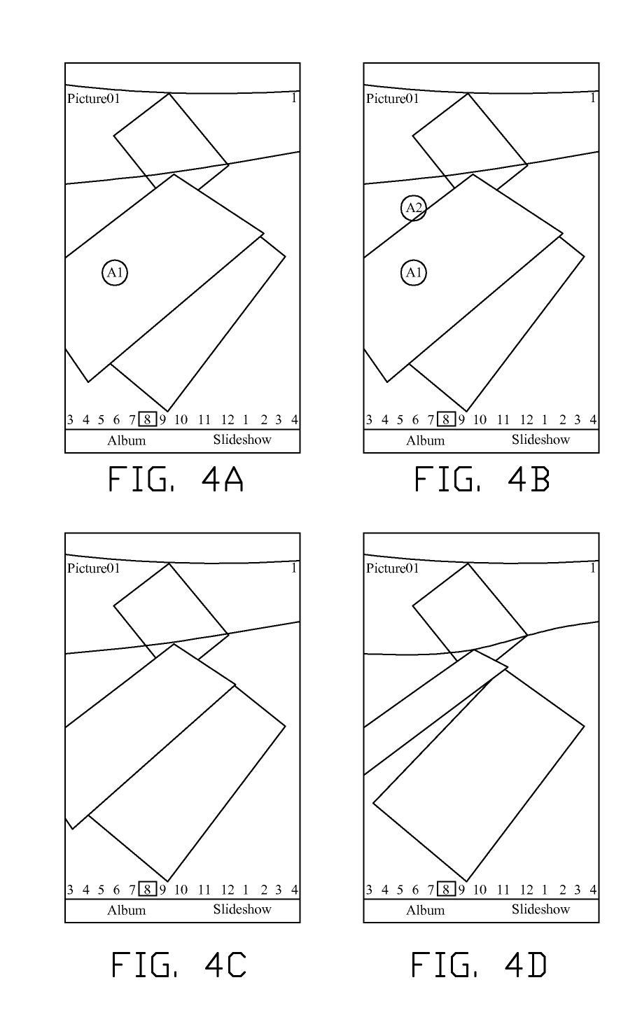

For the purpose of illustration, if the touch type is the drag operation, a touch position is located outside the image, and the drag direction is from the top to the bottom of the touch screen 3, the third program is called to update the X-Y-Z coordinates of the image after the preset time interval, and display the next image. Otherwise, if the touch type is the drag operation, a touch position is located within the image, and the drag direction is from the bottom to the top of the touch screen 3, the third program is called to update the X-Y-Z coordinates of the touched image after the preset time interval, and display the previous image. Referring to FIG. 4A to FIG. 4D, a previous image is displayed on the touch screen 3 when a touch position of the drag operation moves from point “A1” to point “A2” (i.e., FIG. 4A→FIG. 4B→FIG. 4C→FIG. 4D).

In another embodiment, if the touch type is the slide operation and the slide direction is from the left to the right of the touch screen 3, the second program is called to display the images of a previous time period (e.g., a previous calendar month). In other words, the second program slides the image out of a right side of the touch screen 3, and displays the images of the previous time period at a center of the touch screen 3. Otherwise, if the touch type is the slide operation and the slide direction is from the right to the left of the touch screen 3, the second program is called to display the images of a next time period (e.g., a next calendar month). In other words, the second program slides the image out of a left side of the touch screen 3, and displays the images of the next time period at a center of the touch screen 3.

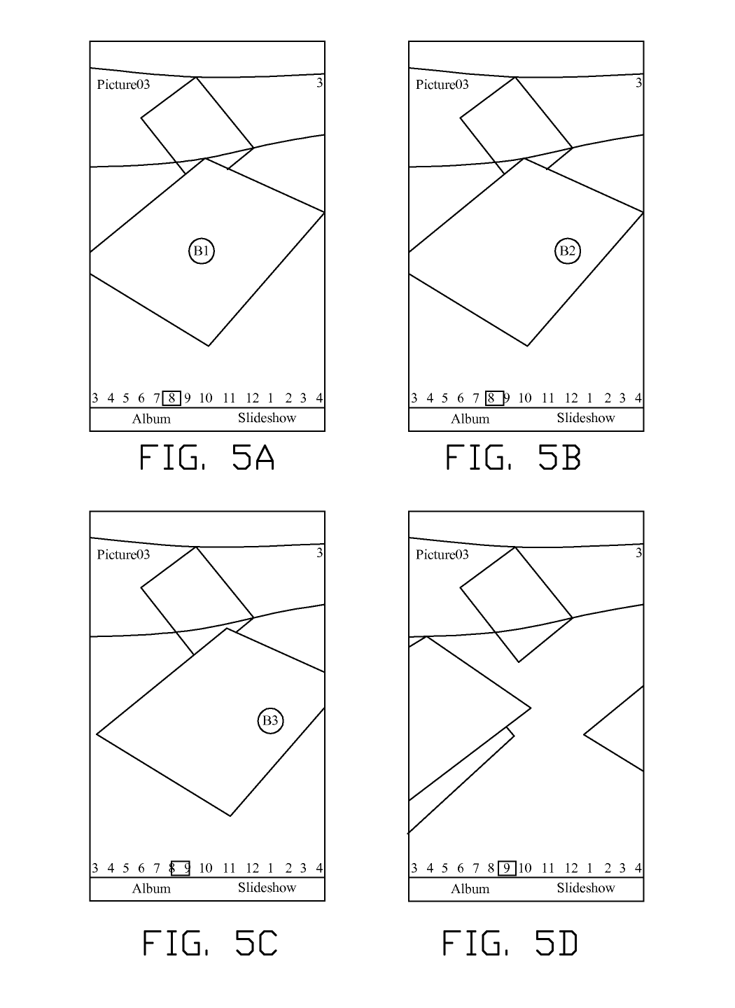

In other embodiment, if the touch type is the drag operation, and the drag direction is from the left to the right of the touch screen 3, the third program is called to update the X-Y-Z coordinates of the image after the preset time interval, and display images of the previous time period. Otherwise, if the touch type is the drag operation, and the drag direction is from the right to the left of the touch screen 3, the third program is called to update the X-Y-Z coordinates of the image after the preset time interval, and display images of the next time period. Referring to FIG. 5A to FIG. 5D, the images of the next calendar month (e.g., September) is displayed on the touch screen 3 when a touch position of the drag operation moves from point “B1” to point “B2”, and further to point “B3” (i.e., FIG. 5A→FIG. 5B→FIG. 5C→FIG. 5D).

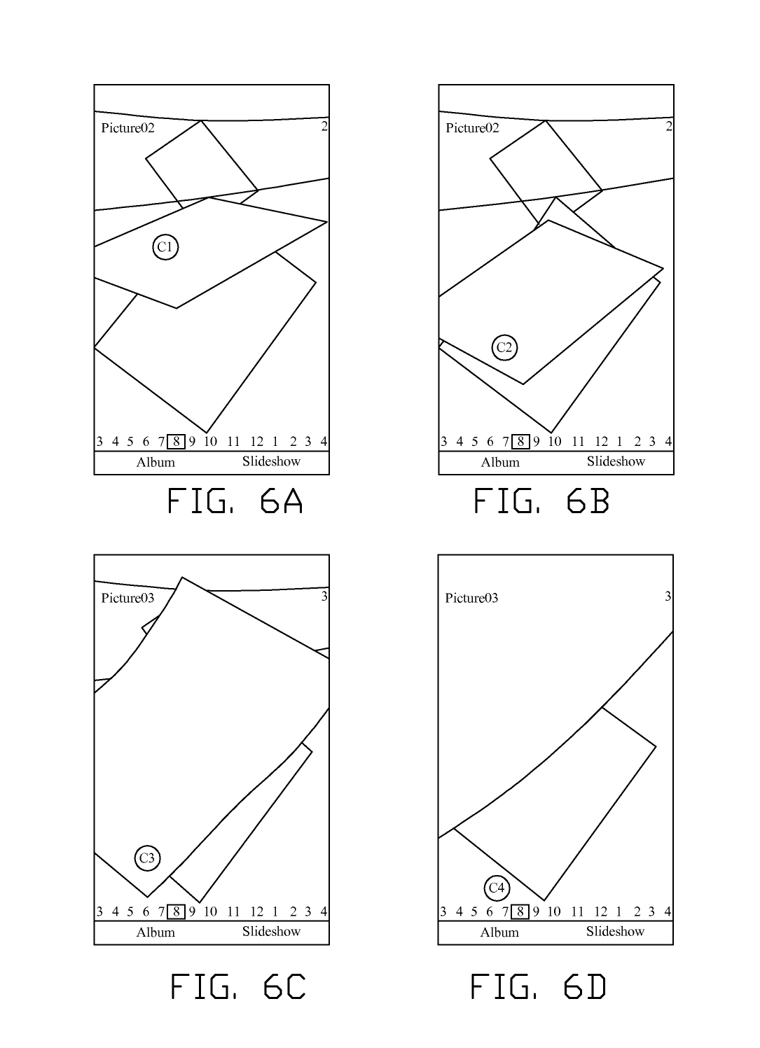

In other embodiment, if the touch type is the drag operation, a touch position is located within the image, and the drag direction is from the top to the bottom of the touch screen 3, the third program is called to delete the touched image. Referring to FIG. 6A to FIG. 6D, the touched image is deleted from the touch screen 3 when a touch position of the drag operation moves from point “Cl” to point “C4” (i.e., FIG. 6A→FIG. 6B→FIG. 6C→FIG. 6D).

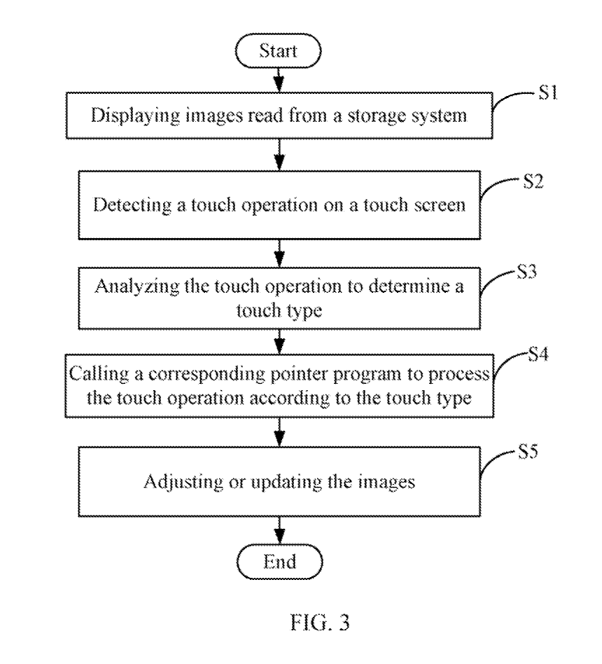

FIG. 3 is a flowchart of one embodiment of a method for managing image browsing in the electronic device 5 with the touch screen 3. Depending on the embodiment, additional blocks may be added, others removed, and the ordering of the blocks may be changed.

In block S1, the displaying module 201 reads image files from the album directory 21 stored in the storage system 2 of the electronic device 5, and displays images of the image files on the touch screen 3 correspondingly.

In block S2, the detecting module 202 detects a touch operation on the touch screen 3.

In block S3, the analyzing module 203 analyzes the touch operation to determine a touch type of the touch operation. In one embodiment, the touch type may be a tap operation, a slide operation, or a drag operation. As mentioned above, if the touch type is the tap operation, touch information of the tap operation may include a touch position of the tap. If the touch type is the slide operation, touch information about the slide operation may include a slide path and a slide direction of the slide. If the touch type is the drag operation, touch information about the drag operation may include a drag path, a drag direction, and a drag distance of the drag.

In block S4, the processing module 204 calls a corresponding pointer program to process the touch operation according to the touch type. As mentioned above, the pointer program may be a first program for processing the touch operation of the tap operation, a second program for processing the touch operation of the slide operation, or a third program for processing the touch operation of the drag operation.

In block S5, the processing module 204 adjusts or updates the images according to the corresponding pointer program. In one embodiment, if the touch type is the tap operation, the first program is called to adjust a display scale of the image, for example, enlarging the image. If the touch type is the slide operation, the second program is called to display a next image or a previous image according to the slide path and the slide direction. If the touch type is the drag operation, the third program is called to update X-Y-Z coordinates of the image after a preset time interval (e.g., 0.5 seconds) according to the drag path, the drag direction, and the drag distance, and display a next image or a previous image according to the drag path and the drag direction. A detailed description refers to paragraphs [0019]-[0022].

In other embodiment, the method may further include a block of: if the touch type is the drag operation, a touch position is located within the image, and the drag direction is from the top to the bottom of the touch screen 3, the third program is called to delete the touched image.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for the management of image browsing in an electronic device comprising a touch screen, the method comprising:
reading image files from a storage system of the electronic device, and displaying images of the image files on the touch screen;
detecting a touch operation on the touch screen;
analyzing the touch operation to determine a touch type, wherein the touch type is selected from the group consisting of a tap operation, a slide operation, and a drag operation; and
calling a corresponding pointer program to process the touch operation according to the touch type, wherein the pointer program is selected from the group consisting of a first program for processing the touch operation of the tap operation, a second program for processing the touch operation of the slide operation, and a third program for processing the touch operation of the drag operation, and wherein
if the touch type is the tap operation, the first program is called to adjust a display scale of the image files;
if the touch type is the slide operation, the second program is called to display a next image or a previous image according to a slide path and a slide direction; and
if the touch type is the drag operation, the third program is called to update X-Y-Z coordinates of the image after a preset time interval according to a drag path, a drag direction, and a drag distance, and display a next image or a previous image according to the drag path and the drag direction.

2. The method according to claim 1, wherein the second program is called to display a next image or a previous image according to a slide path and a slide direction comprises:
displaying the next image, if the touch type is the slide operation and the slide direction is from the top to the bottom of the touch screen; and
displaying the previous image, if the touch type is the slide operation and the slide direction is from the bottom to the top of the touch screen.

3. The method according to claim 1, wherein the third program is called to update X-Y-Z coordinates of the image and display images of a next time period or images of a previous time period comprises:
updating the X-Y-Z coordinates of the image after the preset time interval, and displaying the next image, if the touch type is the drag operation, a touch position is located outside the image, and the drag direction is from the top to the bottom of the touch screen; and
updating the X-Y-Z coordinates of the image after the preset time interval, and displaying the previous image, if the touch type is the drag operation, a touch position is located within the image, and the drag direction is from the bottom to the top of the touch screen.

4. The method according to claim 1, further comprising:
if the touch type is the drag operation, a touch position is located within the image, and the drag direction is from the top to the bottom of the touch screen, the third program is called to delete the touched image.

5. The method according to claim 1, wherein the electronic device is selected from the group consisting of a cell phone, a digital camera, and a personal digital assistant (PDA).

6. A method for the management of image browsing in an electronic device comprising a touch screen, the method comprising:
reading image files from a storage system of the electronic device, and displaying images of the image files on the touch screen;
detecting a touch operation on the touch screen;
analyzing the touch operation to determine a touch type, wherein the touch type is selected from the group consisting of a tap operation, a slide operation, and a drag operation; and
calling a corresponding pointer program to process the touch operation according to the touch type, wherein the pointer program is selected from the group consisting of a first program for processing the touch operation of the tap operation, a second program for processing the touch operation of the slide operation, and a third program for processing the touch operation of the drag operation, and wherein:
if the touch type is the tap operation, the first program is called to adjust a display scale of the image files;
if the touch type is the slide operation, the second program is called to display images of a next time period or images of a previous time period according to a slide path and a slide direction; and
if the touch type is the drag operation, the third program is called to update X-Y-Z coordinates of the image after a preset time interval according to a drag path, a drag direction, and a drag distance, and display images of a next time period or images of a previous time period according to the drag path and the drag direction.

7. The method according to claim 6, wherein the second program is called to display images of a next time period or images of a previous time period according to a slide path and a slide direction comprises:
displaying the images of the previous time period, if the touch type is the slide operation and the slide direction is from the left to the right of the touch screen; and
displaying the images of the next time period, if the touch type is the slide operation and the slide direction is from the right to the left of the touch screen.

8. The method according to claim 6, wherein the third program is called to update X-Y-Z coordinates of the image and display images of a next time period or images of a previous time period comprises:
updating the X-Y-Z coordinates of the image after the preset time interval, and displaying images of the previous time period, if the touch type is the drag operation and the drag direction is from the left to the right of the touch screen; and
updating the X-Y-Z coordinates of the image after the preset time interval, and displaying images of the next time period, if the touch type is the drag operation and the drag direction is from the right to the left of the touch screen.

9. The method according to claim 6, further comprising:
if the touch type is the drag operation, a touch position is located within the image, and the drag direction is from the top to the bottom of the touch screen, the third program is called to delete the touched image.

10. The method according to claim 6, wherein the electronic device is selected from the group consisting of a cell phone, a digital camera, and a personal digital assistant (PDA).

11. A system for the management of image browsing in an electronic device comprising a touch screen, comprising:
a displaying module operable to read image files from a storage system of the electronic device, and display images of the image files on the touch screen;
a detecting module operable to detect a touch operation on the touch screen;
an analyzing module operable to analyze the touch operation to determine a touch type, wherein the touch type is selected from the group consisting of a tap operation, a slide operation, and a drag operation; and
a processing module operable to call a corresponding pointer program to process the touch operation according to the touch type, wherein:
if the touch type is the tap operation, a first program of the pointer program is called to adjust a display scale of the image files;
if the touch type is the slide operation, a second program of the pointer program is called to display a next image or a previous image according to a slide path and a slide direction; and
if the touch type is the drag operation, a third program of the pointer program is called to update X-Y-Z coordinates of the image after a preset time interval according to a drag path, a drag direction, and a drag distance, and display a next image or a previous image according to the drag path and the drag direction.

12. The system according to claim 11, wherein a second program of the pointer program is called to display a next image or a previous image according to a slide path and a slide direction comprises:
displaying the next image, if the touch type is the slide operation and the slide direction is from the top to the bottom of the touch screen; and
displaying the previous image, if the touch type is the slide operation and the slide direction is from the bottom to the top of the touch screen.

13. The system according to claim 11, wherein a third program of the pointer program is called to update X-Y-Z coordinates of the image and display images of a next time period or images of a previous time period comprises:
updating the X-Y-Z coordinates of the image after the preset time interval, and displaying the next image, if the touch type is the drag operation, a touch position is located outside the image, and the drag direction is from the top to the bottom of the touch screen; and
updating the X-Y-Z coordinates of the image after the preset time interval, and displaying the previous image, if the touch type is the drag operation, a touch position is located within the image, and the drag direction is from the bottom to the top of the touch screen.

14. The system according to claim 11, wherein the processing module further operable to:
if the touch type is the drag operation, a touch position is located in the image, and the drag direction is from the top to the bottom of the touch screen, a third program is called by the processing module to delete the touched image.

15. The system according to claim 11, wherein the processing module further operable to:
if the touch type is the slide operation, the second program is called to display images of a next time period or images of a previous time period according to a slide path and a slide direction; and
if the touch type is the drag operation, the third program is called to update X-Y-Z coordinates of the image after a preset time interval according to a drag path, a drag direction, and a drag distance, and display images of a next time period or images of a previous time period according to the drag path and the drag direction.

16. The system according to claim 15, wherein the second program is called to display images of a next time period or images of a previous time period according to a slide path and a slide direction comprises:
displaying the images of the previous time period, if the touch type is the slide operation and the slide direction is from the left to the right of the touch screen; and
displaying the images of the next time period, if the touch type is the slide operation and the slide direction is from the right to the left of the touch screen.

17. The system according to claim 15, wherein the third program is called to update X-Y-Z coordinates of the image and display images of a next time period or images of a previous time period comprises:
updating the X-Y-Z coordinates of the image after the preset time interval, and displaying images of the previous time period, if the touch type is the drag operation and the drag direction is from the left to the right of the touch screen; and
updating the X-Y-Z coordinates of the image after the preset time interval, and displaying images of the next time period, if the touch type is the drag operation and the drag direction is from the right to the left of the touch screen.

18. The system according to claim 15, the processing module further operable to:
if the touch type is the drag operation, a touch position is located within the image, and the drag direction is from the top to the bottom of the touch screen, the third program is called by the processing module to delete the touched image.

19. The system according to claim 11, wherein the electronic device is selected from the group consisting of a cell phone, a digital camera, and a personal digital assistant (PDA).
